(19) United States
(12) Patent Application Publication
(10) Pub. No.: US 2024/0352658 A1
(43) Pub. Date: Oct. 24, 2024

(54) LAUNDRY TREATMENT APPARATUS

(71) Applicant: LG ELECTRONICS INC., Seoul (KR)

(72) Inventors: Taejun YOON, Seoul (KR); Hyunggyu LIM, Seoul (KR); Jongsung KIM, Seoul (KR)

(73) Assignee: LG ELECTRONICS INC., Seoul (KR)

(21) Appl. No.: 18/640,809

(22) Filed: Apr. 19, 2024

(30) Foreign Application Priority Data
Apr. 20, 2023 (KR) 10-2023-0052169

(51) Int. Cl. D06F 58/10; D06F 58/26; D06F 59/02

(52) U.S. Cl. CPC D06F 58/10; D06F 58/26; D06F 59/02

(57) ABSTRACT

A laundry treatment apparatus includes a treatment space to provide a space for accommodating the laundry therein, a supply device supplying at least one of air or steam to the treatment space, a holder fixed to each of the first side surface and the second side surface, and a support body supported by the holder to divide the treatment space into an upper space and a lower space. The holder may include a holder body fixed to the first side surface or the second side surface, a through hole provided in one surface of the holder body facing the first or second side surface having the holder body fixed thereto, a light source provided inside the holder body, and a light guide provided in a bar shape within the holder body to transmit light supplied from the light source in a length direction of the through hole.

### CROSS REFERENCE TO RELATED APPLICATIONS

This non-provisional application claims the benefit under 35 U.S.C. § 119(a) to Patent Application No. 10-2023-0052169, filed in the Republic of Korea on Apr. 20, 2023, which is hereby expressly incorporated by reference into the present application.

### BACKGROUND OF THE DISCLOSURE

### Field of the Disclosure

The present disclosure relates to a laundry treatment apparatus.

### Discussion of the Related Art

A laundry treatment apparatus refers to a device developed to wash and dry laundry at home or in a dry cleaner and to remove wrinkles on laundry. There are a washing machine for washing laundry, a dryer for drying laundry, a drying washing machine having both a washing function and a drying function, a laundry manager for refreshing laundry, a steamer for removing wrinkles on laundry, and the like, which are classified as the laundry treatment apparatuses.

In particular, the laundry manager is a device that allows laundry to be kept comfortable and clean. The laundry manager can shake off fine dust attached to laundry, deodorize odors, dry laundry, and add fragrance to laundry. In addition, it is possible to prevent the occurrence of static electricity, remove wrinkles on laundry by using dehumidified air or steam, and sterilize laundry.

Some of the conventional laundry treatment apparatuses may be equipped with is a light emitting unit for illuminating a treatment space that provides a space in which laundry is accommodated. Since the light emitting unit provided in the conventional laundry treatment apparatus is provided to emit light from an upper surface to a bottom surface of the treatment space, there is a disadvantage in that the brightness of the entire treatment space cannot be evenly maintained. If the brightness is different for each area of the treatment space, it is difficult to check whether foreign substances remain in the laundry, and a problem that causes glare to a user may occur.

### SUMMARY OF THE DISCLOSURE

Accordingly, embodiments of the present disclosure are directed to a laundry treatment apparatus that substantially obviates one or more problems due to limitations and disadvantages of the related art.

One object of the present application is to provide a laundry treatment apparatus capable of evenly maintaining the brightness of a treatment space in which a treatment target is accommodated.

In addition, another object of the present application is to provide a laundry treatment apparatus equipped with a light source and a light guide provided in a holder of a support body that provides a space where the treatment target is placed.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a laundry treatment apparatus according to one embodiment of the present disclosure may include a treatment space having a front surface with an entrance formed therein, a rear surface located at a position opposite to the front surface, and first and second side surfaces connecting the front surface and the rear surface to provide a space for accommodating the laundry therein, a supply device supplying at least one of air or steam to the treatment space, a holder fixed to each of the first side surface and the second side surface, and a support body supported by the holder to divide the treatment space into an upper space and a lower space.

The holder may include a holder body fixed to the first side surface or the second side surface, a through hole provided in one surface of the holder body facing the first or second side surface having the holder body fixed thereto, a light source provided inside the holder body, and a light guide part provided in a bar shape within the holder body to transmit light supplied from the light source in a length direction of the through hole.

The through hole may include a slit with a length treater than a height.

The light source may include a single LED configured to discharge light to one of both ends of the light guide part in the bar shape.

The light source may be fixed to the holder body to come in contact with one end of the light guide part,

The light source may include a first LED discharging light to one of both ends of the light guide part in the bar shape and a second LED discharging light to the other end of the light guide part.

The light guide part may be fixed to the holder body to close the through hole.

The apparatus may further include a sealing part blocking ambient air from being introduced into a space between the light guide part and the through hole.

The apparatus may further include a diffusion part provided to the light guide part to diffuse light supplied from the light source into the light guide part.

The diffusion part may include a multitude of grooves provided to the light guide part along a length direction of the through hole.

At least one of a width of each of the grooves or a spacing between the grooves may be set differently depending on a distance between the corresponding groove and the light source.

The width of each of the grooves may be set to decrease as the distance from the light source increases.

The spacing between the grooves may be set to decrease as the distance from the light source increases.

At least one of a depth of each of the grooves and a vertex curvature of each of the grooves may be set differently depending on a distance between the corresponding groove and the light source.

A depth of each of the grooves may be set to decrease as a distance from the light source increases.

A vertex curvature of each of the grooves may be set to decrease as the distance from the light source increases.

The holder body may include a lower body forming a lower surface of the holder body and supporting the light guide part and an upper body fixed to the lower body to form an upper surface of the holder body and covering an upper surface of the light guide part, wherein a thickness of the lower body may be set greater than that of the upper body.

The apparatus may further include a fixing body fixing the holder body to the first side surface or the second side surface and maintaining a spacing between the holder body fixed side surface and the through hole.

Accordingly, the present disclosure provides the following effects and/or advantages.

First of all, the present application provides a laundry treatment apparatus capable of evenly maintaining the brightness of a treatment space in which a treatment target is accommodated.

In addition, the present application provides a laundry treatment apparatus equipped with a light source and a light guide provided in a holder of a support body that provides a space where the treatment target is placed.

Effects obtainable from the present disclosure may be non-limited by the above-mentioned effects. And, other unmentioned effects can be clearly understood from the following description by those having ordinary skill in the technical field to which the present disclosure pertains.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the present application, illustrate embodiment(s) of the disclosure and together with the description serve to explain the principle of the disclosure. The above and other aspects, features, and advantages of the present disclosure will become more apparent upon consideration of the following description of preferred embodiments, taken in conjunction with the accompanying drawing figures. In the drawings:

FIG. 1 and FIG. 2 show an example of a laundry treatment apparatus;

FIG. 3 shows an example of an air supply device;

FIG. 4 shows an example of a steam supply device;

FIG. 5 and FIG. 6 show an example of a holder that fixes a support body;

FIG. 7 shows an example of a light guide part provided in a holder; and

FIG. 8 shows another embodiment of a holder.

### DETAILED DESCRIPTION OF THE DISCLOSURE

Reference will now be made in detail to the preferred embodiments of the present disclosure. Unless otherwise specified, all terms in the present specification are the same as the general meaning of the terms understood by those skilled in the art to which the present disclosure pertains, and if the terms used in the present specification conflict with the general meaning of the terms, the definitions used in the present specification shall be followed.

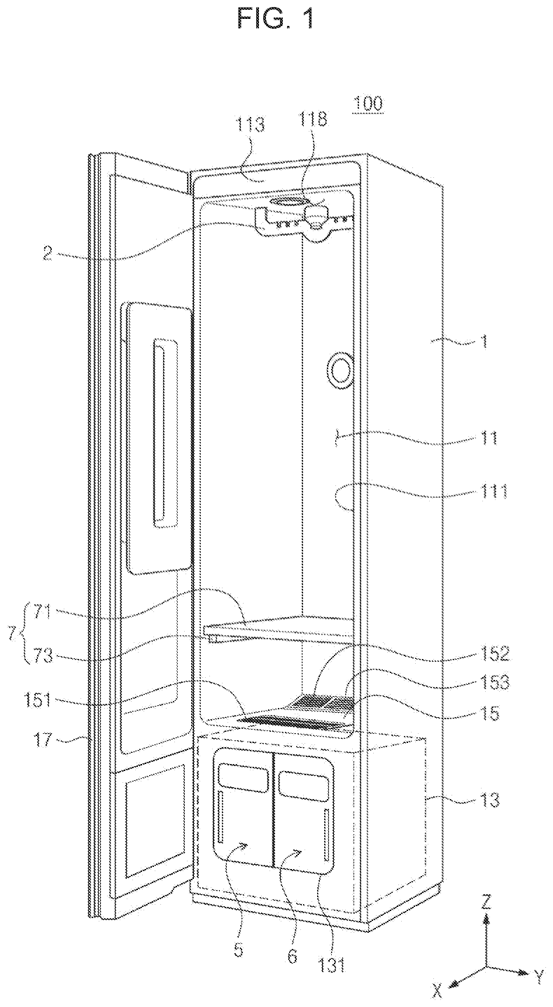

As shown in FIG. 1, a laundry treatment apparatus 100 may include a cabinet 1 forming an exterior, a treatment space 11 provided inside the cabinet to provide a space in which a treatment target (hereinafter, laundry) is accommodated, and an installation space 13 in which a supply device 3 and 4 supplying a fluid to the treatment space 11 is mounted. The treatment space 11 and the installation space 13 may be divided from each other through a partition wall 15.

A front surface 113 of the cabinet 1 is provided with an entrance 111 communicating with the treatment space 11 and a mounting recess 131 providing a space in which at least one of a drain part 5 and a water supply part 6 is mounted. The water supply part 6 may be provided to supply water to the supply device 3 and 4, and the drain part 5 may be provided to store water discharged from the supply device 3 and 4.

The entrance 111 may be configured to be opened and closed by a door 17 rotatably fixed to the cabinet 1. The door 17 may be configured in a shape capable of opening and closing only the entrance 111, or may be configured in a shape capable of opening and closing the entrance 111 and exposing (exposure of the drainage part and the water supply part) of the mounting recess 131 as shown in the drawing.

An upper surface 118 of the treatment space 11 may be provided with a hanger support part 2 to which laundry or hangers on which laundry are mounted are detachably fixed, and the partition wall 15 may be provided with a first communication hole 151, a second communication hole 152, and a third communication hole 153, which connect the treatment space 11 and the installation space 13.

The treatment space 11 may be provided with a space forming part 7 for providing a space in which laundry are placed. The space forming part 7 may include a support body 71 for providing a space for supporting laundry and a holder 73 fixed to the treatment space 11 to fix a position of the support body 71. The support body 71 may be provided as a board that divides the inside of the treatment space 11 into an upper space and a lower space.

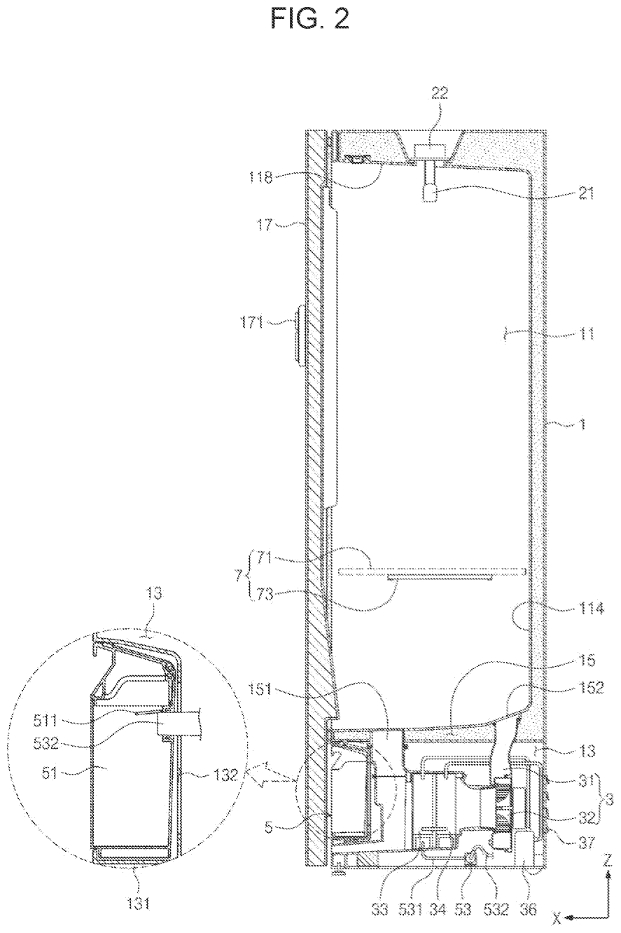

As shown in FIG. 2, the hanger support part 2 may include a support bar 21 fixed to the upper surface 118 of the treatment space to support laundry and a driving unit 22 for vibrating the support bar 21 inside the treatment space 11.

The supply device 3 and 4 may be provided to include at least one of an air supply device 3 for supplying air to the treatment space 11 and a steam supply device 4 for supplying steam to the treatment space 11.

The air supply device 3 may be provided to dehumidify the air discharged from the treatment space 11, heat the dehumidified air, and supply the heated air to the treatment space 11.

The air supply device 3 may include a duct 31 provided to connect the first communication hole 151 and the second communication hole 152, a fan 32 rotatably provided inside the duct to move air from the first communication hole 151 to the second communication hole 152, and a heat exchanger 33, 34, 35, 36, and 37 for sequentially dehumidifying and heating the air introduced into the duct 31.

The heat exchanger may be provided as a heat pump. That is, the heat exchanger may include a refrigerant pipe 37 forming a circulation path of a refrigerant, an evaporator 33 fixed to the refrigerant pipe 37 and positioned inside the duct 31 (located between the first communication hole and the fan), and a condenser 34 fixed to the refrigerant pipe 37 and positioned inside the duct 31 (located between the evaporator and the fan). The refrigerant circulates along the refrigerant pipe 37 through the compressor 36 fixed to the outside of the duct 31, and a means (i.e., a pressure regulator) for controlling the pressure of the refrigerant moving from the condenser to the evaporator may be provided to the refrigerant pipe 37.

The air discharged from the treatment space 11 is condensed while passing through the evaporator 33. The condensed water discharged from the air passing through the evaporator 33 may be discharged from the duct 31 through the drain part 5.

The drain part 5 may include a drain tank 51 detachably fixed to the mounting recess 131, a first drain pipe 531 guiding condensed water inside the duct 31 to a drain pump 53, and a second drain pipe 532 guiding condensed water discharged from the drain pump 53 to the drain tank 51.

The installation space 13 may be connected to the mounting recess 131 through the mounting recess communication hole 132, and the second drain pipe 532 may be connected to the drain tank 51 through the mounting recess communication hole 132. In this case, the drain tank 51 may include a drain tank connection pipe into which the second drain pipe 532 is inserted and a drain tank valve 511 configured to control opening and closing of the drain tank connection pipe.

The second drain pipe 532 may be exposed to the mounting recess 131 through the mounting recess communication hole 132, and may be inserted into the drain tank connection pipe when the drain tank 51 is fixed to the mounting recess 131. When the second drain pipe 532 is inserted into the drain tank connection pipe, the drain tank valve 511 may be provided as a check valve that opens the drain tank connection pipe.

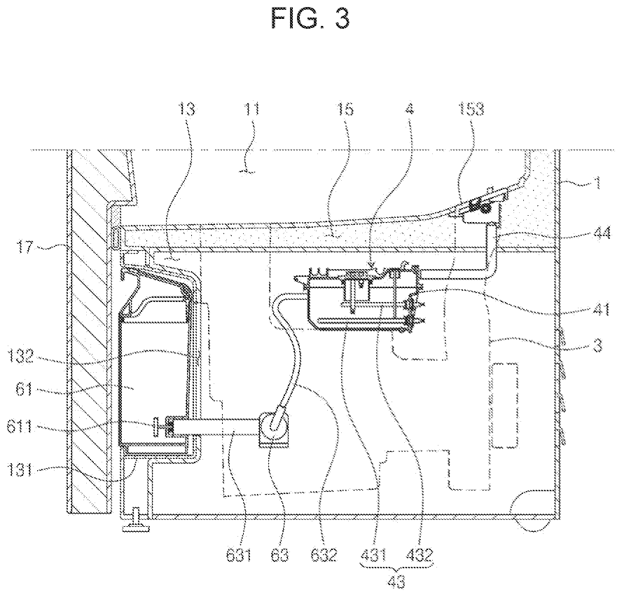

As shown in FIG. 3, the steam supply device 4 may include a storage unit 41 provided in the installation space 13 to store water, a heating unit 43 for heating the water inside the storage unit, and a supply pipe 44 for guiding the steam discharged from the storage unit 41 to the treatment space 11. One end of the supply pipe 44 may be fixed to the storage unit 41 and the other end thereof may be fixed to the third communication hole 153 of the partition wall.

The steam supply device 4 may be provided to be supplied with water through the water supply part 6. The water supply part 6 may include a water supply tank 61 detachably fixed to the mounting recess 131, a water supply pump 63 fixed to the installation space 13, a first water supply pipe 631 guiding water inside the water supply tank 61 to the water supply pump 63, and a second water supply pipe 632 guiding water discharged from the water supply pump 63 to the storage unit 41.

The water supply tank 61 may be provided with a water supply tank connection pipe into which the first water supply pipe 631 is inserted and a water supply tank valve 611 that controls opening and closing of the water supply tank connection pipe.

The first water supply pipe 631 may be exposed to the mounting recess 131 through the mounting recess communication hole 132, and may be provided to be inserted into the water supply tank connection pipe when the water supply tank 61 is fixed to the mounting recess 131. When the first water supply pipe 631 is inserted into the water supply tank connection pipe, the water supply tank valve 611 may be provided as a check valve that opens the water supply tank connection pipe.

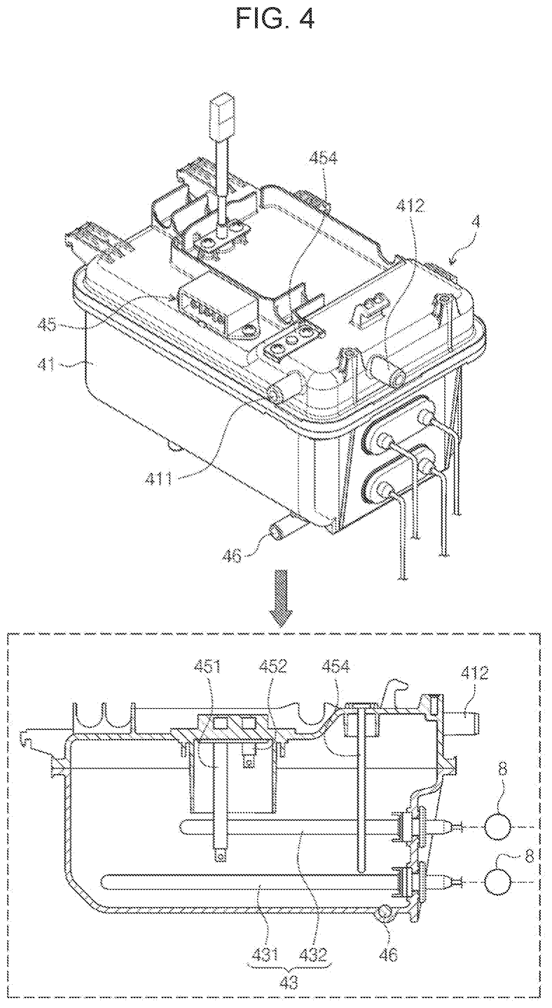

As shown in FIG. 4, the storage unit 41 may include an inlet 411 to which the second water supply pipe 632 is fixed and an outlet 412 to which the supply pipe 44 is fixed. The storage unit 41 may receive water through the inlet 411 and discharge the steam from the inside through the outlet 412.

The heating unit 43 may include a first heater 431 and a second heater 432 positioned inside the storage unit 41. The capacity W of the first heater 431 may be set differently from the capacity of the second heater 432. FIG. 4 shows one example of a case where the capacity of the first heater 431 is set larger than the capacity of the second heater 432.

The steam supply device 4 may further include a temperature sensing unit 46 for sensing the temperature of the water stored in the storage unit 41. The temperature sensing unit 46 may be fixed to a bottom surface of the storage unit 41.

The steam supply device 4 may be provided with a water level sensing unit 45 for sensing the amount of water stored in the storage unit 41. The water level sensing unit 45 may include a first electrode 451, a second electrode 452, and a common electrode 454, which extend from an upper surface of the storage unit 41 toward the bottom surface of the storage unit 41.

When the second heater 432 is provided to be located at a higher point than the first heater 431, a free end of the first electrode 451 is located between the first heater 431 and the second heater 432, a free end of the second electrode 453 is located at a higher point than the second heater 432, and a free end height of the common electrode 454 may be set equal to a free end height of the first electrode 451.

When the free end of the first electrode 451 is connected to the free end of the common electrode 454 by water supplied to the storage unit 41, a control unit may determine that the water level of the storage unit 41 is the free end height of the first electrode 451. Meanwhile, when it is confirmed that the free end of the second electrode 452 is connected to the free end of the common electrode 454 by the water supplied to the storage unit 41, the control unit may determine that the water level of the storage unit 41 is the free end height of the second electrode 452. A free end height of the second electrode 452 may be set equal to the highest water level of the storage unit 41.

In order to measure the voltage of power supplied to the heating unit 43, a voltage sensing unit 8 (e.g., a voltage sensing circuit, etc.) may be further provided to the laundry treatment apparatus 100.

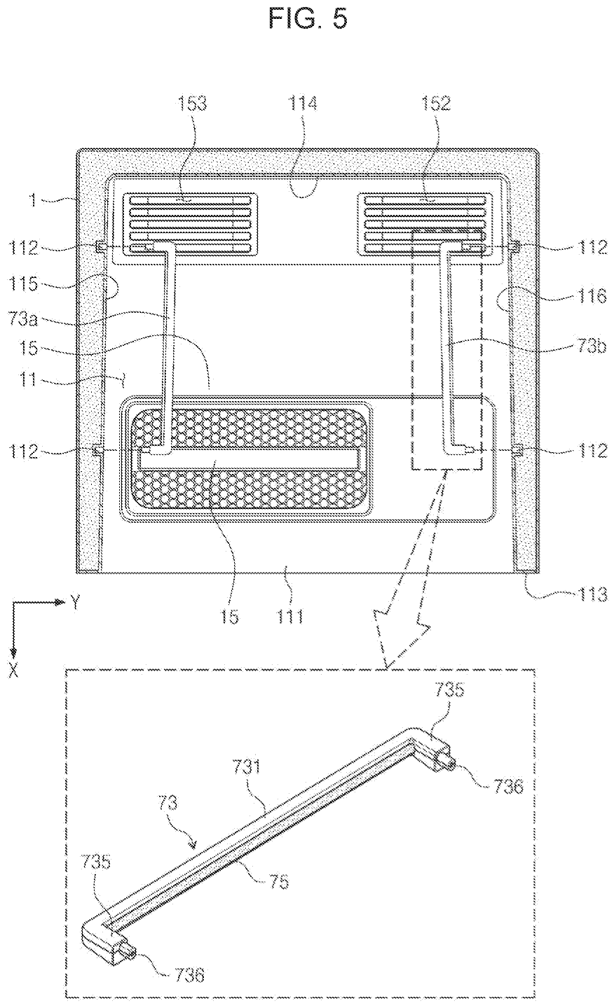

FIG. 5 illustrates an example of the holder 73 constituting the space forming part 7.

The holder 73 may be provided on at least one of a first side surface 115 and a second side surface 116 of the treatment space 11 to support the support body 71, and FIG. 5 illustrates one example of the case where the holder 73 includes a first holder 73a fixed to the first side surface 115 and a second holder 73b fixed to the second side surface 116.

The holder 73 may further include a third holder fixed to a rear surface 114 of the treatment space to support the support body 71.

A holder mounting hole 112 (i.e., a first holder mounting hole) to which the first holder 73a is fixed may be provided in the first side surface 115, and a holder mounting hole 112 (i.e., a second holder mounting hole) to which the second holder 73b is fixed may be provided in the second side surface 116.

The first holder 73a and the second holder 73b may be provided in the same structure or may be provided to have different structures, respectively. Hereinafter, a following description will be made based on the case where the first holder 73a and the second holder 73b are provided in the same structure.

The holder 73 may include a holder body 731 fixed to the first side surface 115 or the second side surface 116, a through hole 734 provided in one surface of the holder body to face the first/second side surface 115/116 to which the holder body 731 is fixed, a light source 74 fixed inside the holder body 731, and a light guide part 75 for transmitting the light supplied from the light source 74 in a length direction of the through hole 734.

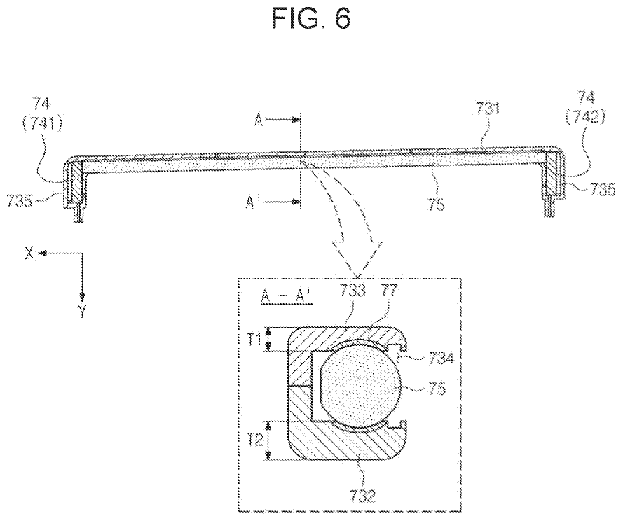

As illustrated in FIG. 6, the holder body 731 may include a lower body 732 forming a lower surface of the holder body and supporting the light guide part 75 and an upper body 733 forming an upper surface of the holder body and covering the upper surface of the light guide part 75. Considering the durability of the holder body 731, the thickness T2 of the lower body is preferably set to be thicker than the thickness T1 of the upper body.

The holder body 731 may be fixed to the side surface 115/116 through a fixing body 735. The fixing body 735 may be provided in a bar shape protruding from each of opposite ends of the holder body 731. Each of the fixing bodies 735 may be provided with a fastening protrusion 736 inserted into the holder mounting hole 112 provided in the side surface 115/116.

The through hole 734 may be provided in a slit shape having a length longer than a height (e.g., a length in the X-axis direction is longer than a length in the Z-axis direction), and the light guide part 75 may be fixed to the holder body 731 to close the through hole 734.

In order to block air or moisture inside the treatment space 11 from flowing into the space between the light guide part 75 and the through hole 734, the holder 73 may further include a sealing part 77.

The light source 74 may be provided as a light-emitting body that is fixed inside the holder body 731 and emits light toward one end of the light guide part 75, and a Light Emitting Diode (LED) may be an example of the light-emitting body.

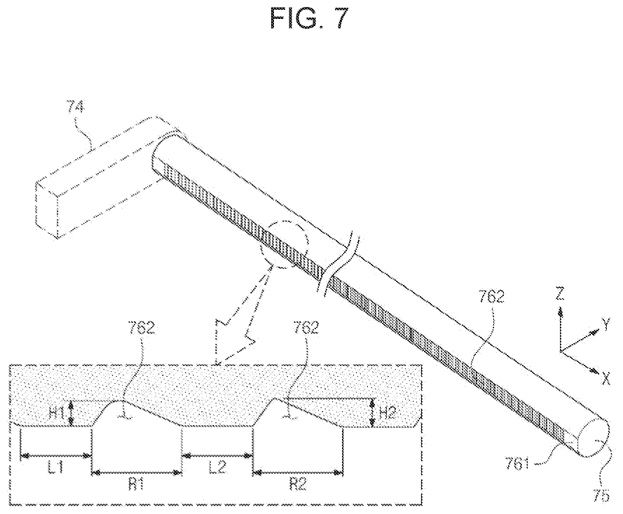

The light source 74 may be provided as a first LED 741 that emits light toward a left end of the light guide part 75 and a second LED 742 that emits light toward a right end of the light guide part 75 as shown in FIG. 6, or as a single LED that emits light toward one end of the light guide part 75 as shown in FIG. 7.

In any case, the light source 74 may be fixed to the holder body 731 to maintain a contact state with the light guide part 75. The maintenance of the light source 74 in contact with the light guide part 75 is found to be advantageous in diffusing light along the light guide part 75.

The light guide part 75 may be provided as a transparent bar or a translucent bar having a circular cross-sectional shape. As illustrated in FIG. 7, when light is incident only on one end of the light guide part 75, it may cause a problem that the brightness of a left end of the light guide part 75 adjacent to the light source 74 may be brighter than that of a right end of the light guide part 75 located opposite to the light source 74. In order to minimize the difference in brightness between both ends of the light guide part 75, a diffusion part 76 may be provided to the light guide part 75.

The diffusion part 76 is a means provided to the light guide part 75 to diffuse light incident from the light source 74 to the light guide part 75 into the light guide part 75, and may include a plurality of grooves 762 provided along the length direction (i.e., X-axis direction) of the light guide part for example.

To facilitate the molding of the grooves 762, a plane 761 may be provided on one surface of the light guide part 75 (e.g., one surface of the light guide part that is not exposed to the outside through a through hole), and the grooves 762 may be provided to be located on the plane 761.

Meanwhile, a width of each of the grooves 762, a spacing between the grooves 762, a depth of each of the grooves 762, and a vertex curvature of each of the grooves 762 may be set differently according to a distance between the corresponding groove and the light source 74.

As shown in FIG. 7, the width of each groove may be set to decrease as the distance from the light source 74 increases (R1>R2), and the spacing between the grooves may be set to decrease as the distance from the light source 74 increases (L1>L2). In addition, the depth of the grooves may decrease as the distance from the light source 74 increases (H1>H2), and the vertex curvature (i.e., a sharp-pointed degree of the vertex) of the grooves may be set to decrease as the distance from the light source increases.

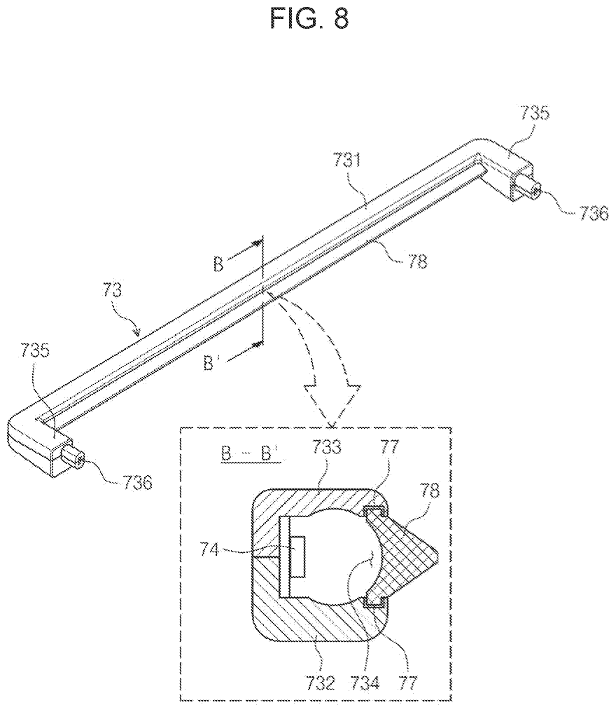

FIG. 8 illustrates another embodiment of the holder 73, in which the holder 73 according to the present embodiment is characterized in including a multitude of light sources 74 fixed to a surface of the space provided by the holder body 731 facing the through hole 734 and a cover 78 (transparent material or translucent material) fixed to the holder body 731 to close the through hole 734. In order to block air or moisture from flowing into the holder body 731, it is preferable that a sealing part 77 is provided between the edge of the cover 78 and the through hole 734.

A cross section of the cover 78 may be provided in a shape protruding toward the surface 115/116 on which the holder 73 is installed. FIG. 8 illustrates an exemplary case in which the cross section of the cover 78 is substantially triangular. When the cover 78 is provided in a shape protruding toward the installation surface of the holder, light may be supplied to an upper region of the treatment space 11 and a lower region of the treatment space 11 as well as the surface 115/116 on which the holder is installed.

Since the light emitted from the light source 74 will be reflected on the side surfaces 115 and 116 of the treatment space 11 in the laundry treatment apparatus 100 provided with the holder 73 described above, the laundry treatment apparatus 100 may illuminate the treatment space 11 with indirect lighting.

When the light source 74 and the light guide part 75 are provided to serve as indirect lighting of the treatment space 11, it will supply light evenly inside the treatment space 11, protect a user from glare, and facilitate the identification of foreign substances remaining in the laundry mounted in the treatment space 11.

Furthermore, when the light source 74 and the light guide part 75 are provided to serve as indirect lighting, the treatment space 11 may be illuminated with soft light, and advantageous effects can be expected from an aesthetic point of view.

It will be appreciated by those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A laundry treatment apparatus comprising:
a treatment space including:
a front surface with an entrance located therein;
a rear surface located opposite the front surface; and
a first side surface and a second side surface connecting the front surface and the rear surface to define a space for accommodating laundry therein;
a supply device configured to supply at least one of air or steam to the treatment space;
a first holder and a second holder fixed to the first side surface and the second side surface, respectively, each of the first holder and the second holder including:
a holder body configured to be fixed to the respective one of the first side surface and the second side surface;
a through hole provided in one surface of the holder body, the through hole facing the respective one of the first side surface and the second side surface;
a light source provided inside the holder body; and
a light guide in the holder body, the light guide being configured to transmit light supplied from the light source along a length direction of the through hole; and
a support body supported by the first holder and the second holder to divide the treatment space into an upper space and a lower space.

2. The laundry treatment apparatus of claim 1, wherein the through hole is a slit.

3. The laundry treatment apparatus of claim 2, wherein the light guide has a bar shape.

4. The laundry treatment apparatus of claim 2, wherein the light source includes a single LED configured to discharge light to one end of the light guide.

5. The laundry treatment apparatus of claim 4, wherein the light source is fixed to the holder body and contacts the one end of the light guide.

6. The laundry treatment apparatus of claim 3, wherein the light source includes:
a first LED configured to discharge the light to a first end of the light guide; and
a second LED configured to discharge the light to a second end of the light guide.

7. The laundry treatment apparatus of claim 6, wherein the light guide is fixed to the holder body to close the through hole.

8. The laundry treatment apparatus of claim 2, wherein the light guide is fixed to the holder body to close the through hole.

9. The laundry treatment apparatus of claim 1, wherein the light guide is fixed to the holder body to close the through hole.

10. The laundry treatment apparatus of claim 9, further comprising a sealing part configured to block ambient air from being introduced into a space between the light guide and the through hole.

11. The laundry treatment apparatus of claim 9, wherein the light guide includes a diffusion part configured to diffuse light supplied from the light source into the light guide.

12. The laundry treatment apparatus of claim 11, wherein the diffusion part includes a plurality of grooves along a length direction of the through hole.

13. The laundry treatment apparatus of claim 12, wherein at least one of a width of each of the grooves or a spacing between each of the grooves is set differently depending on a distance between the corresponding groove and the light source.

14. The laundry treatment apparatus of claim 13, wherein the width of each of the grooves is set to decrease as the distance from the light source increases.

15. The laundry treatment apparatus of claim 13, wherein the spacing between adjacent grooves is set to decrease as the distance from the light source increases.

16. The laundry treatment apparatus of claim 12, wherein at least one of a depth of each of the grooves and a vertex curvature of each of the grooves is set differently depending on a distance between the corresponding groove and the light source.

17. The laundry treatment apparatus of claim 12, wherein a depth of each of the grooves is set to decrease as a distance from the light source increases.

18. The laundry treatment apparatus of claim 17, wherein a vertex curvature of each of the grooves is set to decrease as the distance from the light source increases.

19. The laundry treatment apparatus of claim 9, wherein the holder body includes:
a lower body defining a lower surface of the holder body, the lower body supporting the light guide; and
an upper body defining an upper surface of the holder body, the upper body being fixed to the lower body to cover an upper surface of the light guide, and
wherein a thickness of the upper body is less than a thickness of the lower body.

20. The laundry treatment apparatus of claim 19, wherein each of the first holder and the second holder includes a fixing body configured to fix the holder body to the respective one of the first side surface and the second side surface, the fixing body being configured to maintain a spacing between the respective one of the first side surface and the second side surface and the through hole.
